(19) United States
(12) Patent Application Publication
(10) Pub. No.: US 2008/0169897 A1
(43) Pub. Date: Jul. 17, 2008

(54) TEMPERATURE SWITCH

(76) Inventor: Yu-Kang Yang, Yung-Kang City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/624,170

(22) Filed: Jan. 17, 2007

(51) Int. Cl. H01H 37/52

(52) U.S. Cl. 337/335

(57) ABSTRACT

A temperature switch includes a heat-conductive plate adapted to contact a heating element, an insulating support connected to the plate, and a switching unit mounted on the insulating support and including first and second fixed contact members adapted to be connected electrically and respectively to two electrical wires, and a movable contact member having first and second contact portions for electrical connection with the first and second fixed contact members, respectively. A temperature control unit includes first and second temperature-responsive elements mounted on the heat-conductive plate, and first and second control rods respectively extending from the first and second temperature-responsive elements to the first and second contact portions so as to control the first and second contact portions, respectively. The first and second temperature-responsive elements are deformable when first and second preset deformation temperatures are reached, respectively.

### BACKGROUND OF THE INVENTION

1. Field of the Invention

The invention relates to a temperature switch, more particularly to a temperature switch that has a temperature-sensing capability for controlling the supply of power.

2. Description of the Related Art

Referring to FIGS. 1 to 3, a conventional temperature switch includes a porcelain housing 11 which has a bottom wall 111 with a stepped portion 114, opposite first and second conductors 12, 13 disposed below the bottom wall 111 and connected electrically and respectively to two electrical wires 22, 23, a first conductive plate 14 connected electrically to the first conductor 12, a second conductive plate 15 extending through the stepped portion 114 and connected electrically to the second conductor 13, a resilient conductive plate 16 abutting against the first conductive plate 14, a rod-support seat 17 mounted on a surrounding wall 113 of the housing 11, a porcelain control rod 18 extending slidably in a hole in the rod-support seat 17, a temperature-responsive element 19 disposed in the rod-support seat 17 and abutting against the control rod 18, and a metal cover 10 covering the housing 11 and abutting against a heating element 21 of an electrical appliance (not shown). The resilient conductive plate 16 has a contact part 161 located below the second conductive plate 15, and a dome-shaped portion 162 disposed below and abutting against the control rod 18. The second conductive plate 15 has a downwardly projecting contact part 151 for contacting the contact part 161 of the resilient conductive plate 16. The temperature-responsive element 19 has a curved portion 191 which deforms upon reaching a preset deformation temperature. The preset deformation temperature is set as needed and may be either hot or cold. For example, the temperature switch installed in an electric iron requires a high deformation temperature, while the temperature switch installed in a drinking dispenser requires a low deformation temperature.

When the temperature switch is in an “ON” position, as shown in FIG. 2, the curved portion 191 of the temperature-responsive element 19 convexes upwardly, and is in contact with the cover 10. Furthermore, the control rod 18 is disposed between the curved portion 191 of the temperature-responsive element 19 and the dome-shaped portion 162 of the resilient conductive plate 16. Power is supplied through the electrical wire 22, such that electrical current associated therewith passes through the first conductor 12, the first conductive plate 14, the resilient conductive plate 16, the second conductive plate 15, the second conductor 13, and into the electrical wire 23.

Assuming a high (hot) preset deformation temperature when heat of the heating element 21 is transmitted from the cover 10 to the temperature-responsive element 19, and the preset deformation temperature is reached, the curved portion 191 of the temperature-responsive element 19 will deform and convexes downwardly, as shown in FIG. 3. As a result, the control rod 18 moves the resilient conductive plate 16 away from the contact part 151 of the second conductive plate 15, thereby placing the temperature switch at an “OFF” position.

Although the aforementioned conventional temperature switch can achieve its intended purpose, when movement between components is not smooth, or when the curved portion 191 of the temperature-responsive element 19 fails to deform despite reaching the preset deformation temperature, the “OFF” state of the temperature switch cannot be obtained. Furthermore, to enhance safe use of the electrical appliance, some manufacturers add a fuse to one of the electrical wires 22, 23. However, this complicates assembly of the conventional temperature switch.

### SUMMARY OF THE INVENTION

Therefore, the object of the present invention is to provide a temperature switch that is capable of overcoming the aforementioned drawbacks of the prior art.

According to this invention, a temperature switch comprises a heat-conductive plate adapted to contact a heating element, an insulating support connected to the heat-conductive plate, a switching unit mounted on the insulating support, and a temperature control unit. The switching unit includes first and second fixed contact members adapted to be connected electrically and respectively to two electrical wires, and a movable contact member having a first contact portion for electrical connection with the first fixed contact member, and a second contact portion for electrical connection with the second fixed contact member. The temperature control unit includes spaced-apart first and second temperature-responsive elements mounted on the heat-conductive plate, a first control rod extending from the first temperature-responsive element to the first contact portion so as to control the first contact portion, and a second control rod extending from the second temperature-responsive element to the second contact portion. The first temperature-responsive element is deformable when a first preset deformation temperature is reached. The second temperature-responsive element is deformable when a second preset deformation temperature is reached.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional temperature switch;

FIG. 2 is an assembled sectional view of the conventional temperature switch, illustrating the conventional temperature switch in an “ON” position;

FIG. 3 is a view similar to FIG. 2, but with the conventional temperature switch in an “OFF” position;

FIG. 4 is an exploded perspective view of the preferred embodiment of a temperature switch according to the present invention;

FIG. 5 is an assembled sectional view of the preferred embodiment, illustrating the temperature switch of the present invention in an “ON” position;

FIG. 6 is a view similar to FIG. 5, but illustrating the temperature switch of the present invention in an “OFF” position; and

FIG. 7 is a view similar to FIG. 5, but illustrating the temperature switch of the present invention in another “OFF” position.

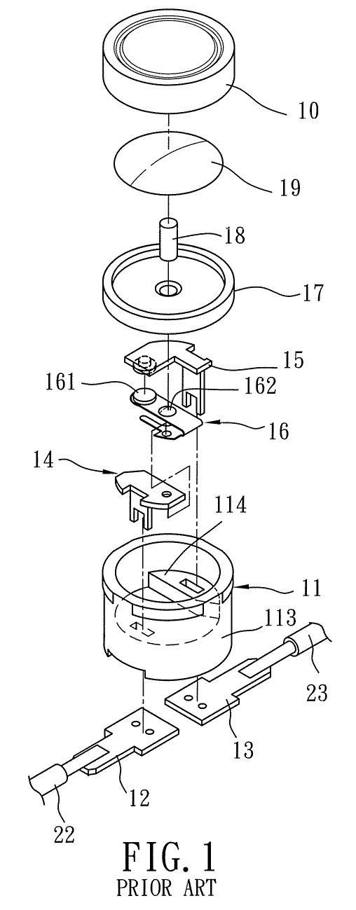

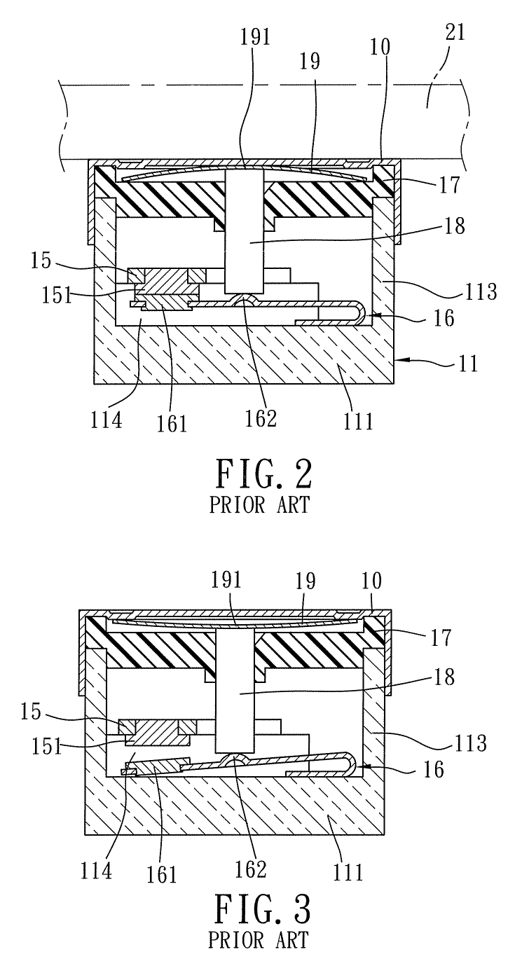

### DETAILED DESCRIPTION OF THE PREFERRED EMBODIMENT

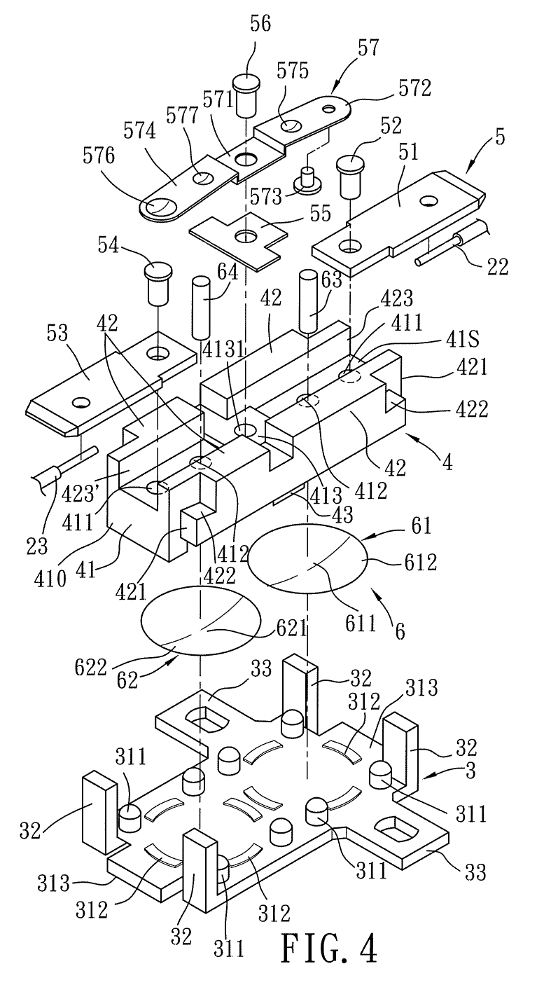

Referring to FIGS. 4 to 7, the preferred embodiment of a temperature switch according to the present invention is adapted to be installed in an electrical appliance (not shown), and is shown to comprise a rectangular heat-conductive plate 3, an insulating support 4, a switching unit 5, and a temperature control unit 6.

The heat-conductive plate 3 is adapted to contact a heating element 21 of the electrical appliance, and includes four clamping legs 32 projecting upwardly and respectively from four corners of the heat-conductive plate 3, two tabs 313 projecting outwardly and respectively from two opposite sides of the heat-conductive plate 3, two sets of spaced-apart pads 312 and two sets of spaced-apart limiting studs 311 projecting from an inner surface of the heat-conductive plate 3, and two side extensions 33 projecting respectively from the other two opposite sides of the heat-conductive plate 3 and connected to the heating element 21. Each set of the limiting studs 311 surrounds the respective set of the pads 312. Each of the tabs 313 is disposed between two adjacent ones of the clamping legs 32. In this embodiment, the number of each set of the pads 312 is four, and the number of each set of the limiting studs 311 is also four.

The insulating support 4 is made of porcelain, and includes an elongated base wall 41, and two opposite sidewalls 410 (only one is visible in FIG. 4) extending downwardly and respectively from two opposite ends of the base wall 41 toward the respective tabs 313. The base wall 41 has a first side (41F) facing the inner surface of the heat-conductive plate 3, and a second side (41S) opposite to the first side (41F). The sidewalls 410, the first side (41F) of the base wall 41, and the heat-conductive plate 3 cooperatively define a receiving space 200. The base wall 41 further has first and second grooves 423, 423′ formed in the second side (41S) thereof, an intermediate raised portion 413 disposed between the first and second grooves 423, 423′, two spaced-apart positioning holes 411 respectively formed proximate to the two opposite ends of the base wall 41, two spaced-apart limiting holes 412 extending through the first and second sides (41F, 41S) and disposed between the positioning holes 411, and an aperture 4131 formed in the intermediate raised portion 413.

The insulating support 4 further includes two pairs of spaced-apart limit blocks 42 projecting upwardly from the second side (41S) of the base wall 41, and two spaced-apart dividing blocks 43 (only one is visible in FIG. 4) projecting downwardly from an intermediate portion of the first side (41F) of the base wall 41 transverse to the length of the base wall 41. Each pair of the limit blocks 42 confine one of the first and second grooves 423, 423′. Each of the limit blocks 42 has a corner provided with a channel 421 and a shoulder part 422 adjacent to the channel 421. Each clamping leg 32 of the heat-conductive plate 3 extends into the channel 421 at the corner of the corresponding limit block 42, and is bent to abut against the shoulder part 422 of the corresponding limit block 42, thereby clamping and retaining the insulating support 4 on the heat-conductive plate 3. The dividing blocks 43 are disposed between the two sets of the limiting studs 311, and divide the receiving space 200 into two receiving sections 201, 202, so that one set of the pads 312 and one set of the limiting studs 311 are located in the receiving section 201, while the other set of the pads 312 and the other set of the limiting studs 311 are located in the receiving section 202.

The switching unit 5 is mounted on the second side (41S) of the base wall 41 of the insulating support 4, and includes a first fixed contact member 51 adapted to be connected electrically to an electrical wire 22 and disposed in the first groove 423, a first pin 52 engaged to one of the positioning holes 411 so as to fix the first fixed contact member 51 to the second side (41S) of the base wall 41, a second fixed contact member 53 adapted to be connected electrically to an electrical wire 23 and disposed in the second groove 423′, a second pin 54 engaged to the other one of the positioning holes 411 so as to fix the second fixed contact member 53 to the second side (41S) of the base wall 41, a fixed conductive plate 55 disposed on top of the intermediate raised portion 413, a movable contact member 57 disposed above the fixed conductive plate 55, and a third pin 56 fixing the fixed conductive plate 55 and the movable contact member 57 to the intermediate raised portion 413.

The movable contact member 57 has first and second contact portions 572, 574 connected electrically and respectively to the first and second fixed contact members 51, 53, and an intermediate contact portion 571 between the first and second contact portions 572, 574 and fixed to the intermediate raised portion 413. The first contact portion 572 extends toward the first groove 423, and has a conductive pin 573, and a first contact point 575 disposed between the conductive pin 573 and the intermediate contact portion 571. The conductive pin 573 is connected electrically and releasably to the first fixed contact member 51 through the first pin 52. The second contact portion 574 extends toward the second groove 423′, and has a second contact point 576, and a third contact point 577 disposed between the second contact point 576 and the intermediate contact portion 571. The second contact point 576 is connected electrically and releasably to the second fixed contact member 53 through the second pin 54.

The temperature control unit 6 includes spaced-apart first and second temperature-responsive elements 61, 62 respectively disposed in the receiving sections 202, 201, and first and second control rods 63, 64. Each of the first and second temperature-responsive elements 61, 62 has a convex portion 611, 621 in contact with the inner surface of the heat-conductive plate 3, and an outer periphery 612, 622 surrounding the convex portion 611, 621. Each set of the limiting studs 311 surrounds and engages the outer periphery 612, 622 of the corresponding one of the first and second temperature-responsive elements 61, 62, thereby restricting the respective one of the first and second temperature-responsive elements 61, 62 within the respective receiving section 202, 201. The first temperature-responsive element 61 is deformable when a first preset deformation temperature is reached. The second temperature-responsive element 62 is deformable when a second preset deformation temperature is reached. In this embodiment, the first preset deformation temperature is 220° C., while the second preset deformation temperature is 250° C.

Each of the first and second control rods 63, 64 has one end abutting against the convex portion 611, 621 of the respective one of the first and second temperature-responsive elements 61, 62, and another end extending slidably through the respective one of the first and second limiting holes 412 to abut respectively against the first contact point 575 of the first contact portion 572 and the third contact point 577 of the second contact portion 574.

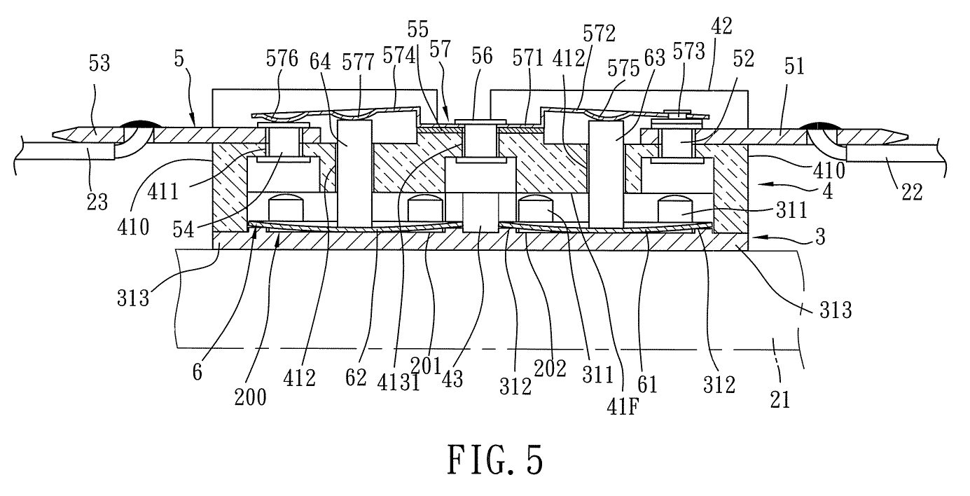

When the temperature switch of the present invention is in an “ON” position, as shown in FIG. 5, the convex portions 611, 621 of the first and second temperature-responsive elements 61, 62 are pressed downwardly and respectively by the first and second control rods 63, 64, and the first and second contact portions 572, 574 of the movable contact member 57 abut respectively against the first and second fixed contact members 51, 52. At this time, electrical current supplied through the electrical wire 22 passes conductively through the first fixed contact member 51, the movable contact member 57, the second fixed contact member 53, and into the electrical wire 23.

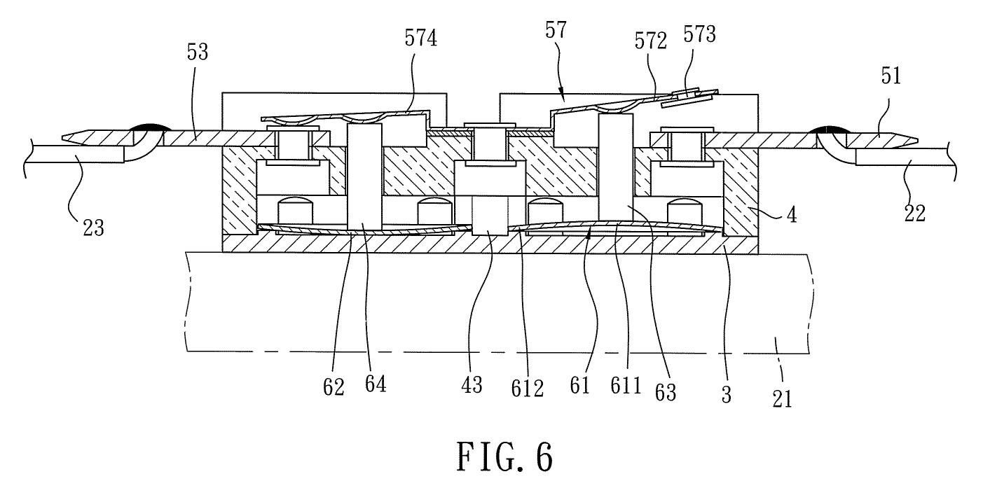

In use, when heat from the heating element 21 is transmitted to the first and second temperature-responsive elements 61, 62, and reaches the first preset deformation temperature, the first temperature-responsive element 61 deforms from a state shown in FIG. 5 to another state shown in FIG. 6. At this time, the convex portion 611 of the first temperature-responsive element 61 pushes the first control rod 63 upwardly, which in turn pushes the first contact portion 572 to move upwardly, thereby moving the conductive pin 573 away from electrical contact with the first fixed contact member 51. This prevents the electrical current from flowing to the movable contact member 57 that results in placing the temperature switch of the present invention to a first “OFF” position, as shown in FIG. 6.

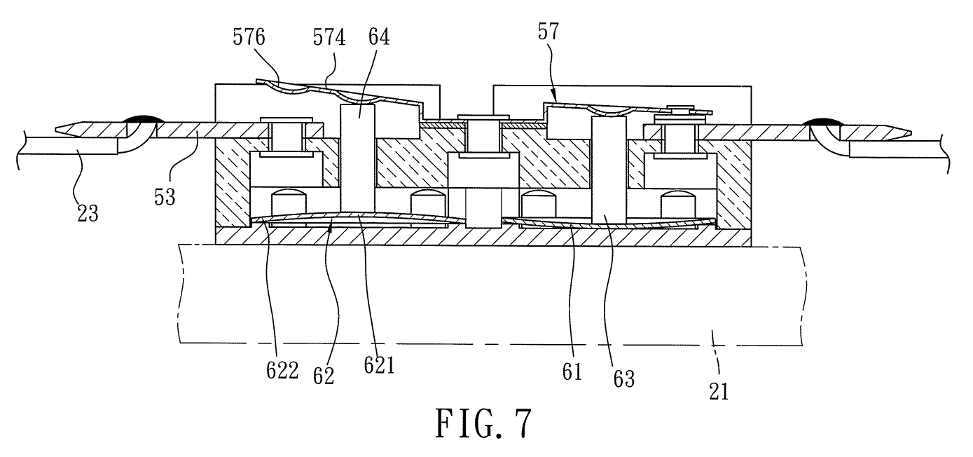

Assuming that the first temperature-responsive element 61 did not deform when the first preset deformation temperature was reached, and assuming further that heat from the heating element 21 continues to rise until the second preset deformation temperature is reached, the second temperature-responsive element 62 deforms from a state shown in FIG. 5 to another state shown in FIG. 7. At this time, the convex portion 621 of the second temperature-responsive element 62 pushes the second control rod 64 upwardly, which in turn pushes the second contact portion 574 to move upwardly, thereby moving the second contact point 576 away from electrical contact with the second fixed contact member 53. This prevents the electrical current from flowing to the second fixed contact member 53 and the electrical wire 23, thereby placing the temperature switch of the present invention to a second “OFF” position, as shown in FIG. 7.

From the aforementioned description, it is apparent that when the first temperature-responsive element 61 is defective so that it may not be relied upon to place the temperature switch to an “OFF” position, the second temperature-responsive element 62 can still be deformed when heat from the heating element 21 reaches the second preset deformation temperature, so that the flow of current through the temperature switch of the present invention can be prevented. Hence, safety is ensured through use of the temperature switch of the present invention. Further, use of a fuse in the temperature switch of the present invention is not needed.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A temperature switch comprising:
a heat-conductive plate adapted to contact a heating element;
an insulating support connected to said heat-conductive plate;
a switching unit mounted on said insulating support and including first and second fixed contact members adapted to be connected electrically and respectively to two electrical wires, and a movable contact member having a first contact portion for electrical connection with said first fixed contact member, and a second contact portion for electrical connection with said second fixed contact member; and
a temperature control unit including spaced-apart first and second temperature-responsive elements mounted on said heat-conductive plate, a first control rod extending from said first temperature-responsive element to said first contact portion so as to control said first contact portion, and a second control rod extending from said second temperature-responsive element to said second contact portion, said first temperature-responsive element being deformable when a first preset deformation temperature is reached, said second temperature-responsive element being deformable when a second preset deformation temperature is reached.

2. The temperature switch of claim 1, wherein said insulating support includes a base wall, and two opposite sidewalls extending from said base wall toward said heat-conductive plate, said base wall having a first side facing said heat-conductive plate, and a second side opposite to said first side, said sidewalls, said first side of said base wall, and said heat-conductive plate cooperatively defining a receiving space, said first and second temperature-responsive elements being disposed in said receiving space, said switching unit being mounted on said second side of said base wall.

3. The temperature switch of claim 2, wherein said base wall further includes first and second grooves formed in said second side of said base wall, and an intermediate raised portion disposed between said first and second grooves, said first and second fixed contact members being fixed respectively in said first and second grooves.

4. The temperature switch of claim 3, wherein said movable contact member further has an intermediate contact portion between said first and second contact portions and fixed to said intermediate raised portion, said first contact portion extending toward said first groove and contacting said first fixed contact member, said second contact portion extending toward said second groove and contacting said second fixed contact member.

5. The temperature switch of claim 4, wherein said base wall further has two spaced-apart limiting holes extending through said first and second sides and receiving slidably and respectively said first and second control rods.

6. The temperature switch of claim 3, wherein said heat-conductive plate has four clamping legs respectively projecting from four corners of said heat-conductive plate and clamping said insulating support.

7. The temperature switch of claim 2, wherein each of said first and second temperature-responsive elements has a convex portion in contact with an inner surface of said heat-conductive plate, and an outer periphery surrounding said convex portion, said heat-conductive plate further having two sets of spaced-apart limiting studs, each set of said limiting studs projecting from said inner surface of said heat-conductive plate and surrounding and engaging said outer periphery of a corresponding one of said first and second temperature-responsive elements, each of said first and second control rods having an end connected to said convex portion of a respective one of said first and second temperature-responsive elements.

8. The temperature switch of claim 6, wherein said insulating support further includes two pairs of spaced-apart limit blocks projecting from said second side of said base wall, each pair of said limit blocks confining one of said first and second grooves, each of said limit blocks having a corner provided with a channel for insertion of one of said clamping legs, and a shoulder part adjacent to said channel, each of said clamping legs being bent to abut against said shoulder part after being inserted into a respective one of said channels.

9. The temperature switch of claim 1, wherein one of said first and second preset deformation temperatures is higher than the other one of said first and second preset deformation temperatures.
